(19) United States
(12) Patent Application Publication
(10) Pub. No.: US 2026/0089415 A1
(43) Pub. Date: Mar. 26, 2026

(54) WEARABLE BLUETOOTH SPEAKERS WITH CLOTHING CLIP

(71) Applicant: John Niemiec, Shelby Township, MI (US)

(72) Inventor: John Niemiec, Shelby Township, MI (US)

(21) Appl. No.: 18/897,919

(22) Filed: Sep. 26, 2024

(51) Int. Cl. H04R 1/02; G06F 3/16; H04R 1/08; H04R 3/12

(52) U.S. Cl. CPC H04R 1/026; G06F 3/162; G06F 3/165; H04R 1/023; H04R 1/025; H04R 1/08; H04R 3/12; H04R 2420/07; H04R 2430/01

(57) ABSTRACT

A wearable audio system may comprise a pair of portable speaker devices. Each speaker device may include a housing, a speaker unit disposed within the housing, and a fastening clip attached to the housing. The fastening clip may be configured to removably secure the speaker device to a user's clothing. Each speaker device may also include a wireless communication module configured to receive audio signals from an audio source device, and a battery configured to power the speaker device. The pair of speaker devices may be configured to be worn by a user with one speaker device positioned below each ear. A method of using the wearable audio system may include attaching the speaker devices to a user's clothing below each ear, wirelessly pairing the devices with an audio source, receiving audio signals, and outputting audio content through the speaker units.

### CROSS-REFERENCE TO RELATED APPLICATIONS

Under provisions of 35 U.S. C. § 119(e), this application claims the benefit of U.S. Provisional Patent Application No. 63/585,727 , filed Sep. 27, 2023, the entire contents of which are hereby incorporated by reference.

### FIELD OF THE INVENTION

The present disclosure relates to the field of personal audio devices. More specifically, it pertains to wearable speaker systems designed for portable audio playback while maintaining environmental awareness.

### BACKGROUND

The present disclosure relates generally to audio devices, and more particularly to wearable speakers that can be attached to clothing. Traditional headphones and earbuds are commonly used to listen to audio content. However, these devices may isolate users from their surroundings, potentially creating safety hazards in workplaces or while walking in public areas. Additionally, prolonged use of earbuds at high volumes may risk damage to the user's hearing.

### BRIEF OVERVIEW

In various embodiments, a wearable audio system includes a pair of portable speakers configured to be clipped onto a user's clothing near the ears. The speakers may wirelessly connect to an audio source device using Bluetooth technology. This arrangement may allow users to listen to audio content while maintaining awareness of their environment.

The foregoing is a non-limiting summary of the invention, which is defined by the attached claims. Other aspects, embodiments, and features will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention.

The foregoing summary is illustrative only and is not intended to be in any way limiting. In addition to the illustrative aspects, embodiments, and features described above, further aspects, embodiments, and features will become apparent by reference to the drawings and the following detailed description. Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. The accompanying drawings, which are incorporated in and constitute a part of this disclosure, illustrate various embodiments of the present disclosure. The drawings contain representations of various trademarks and copyrights owned by the Applicant.

In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose. Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 shows front and rear views of an exemplary wearable speaker device.

FIG. 2 illustrates how the wearable speaker device may be clipped onto clothing.

FIG. 3 shows exemplary configurations and colors of wearable speaker devices.

FIG. 4 depicts a user wearing an exemplary wearable speaker device.

FIG. 5 illustrates another user wearing an exemplary wearable speaker device.

FIG. 6 shows a detailed view of an exemplary wearable speaker device.

FIG. 7 depicts internal components of an exemplary wearable speaker device.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Thus, for example, any sequence(s) and/or temporal order of steps of various processes or methods that are described herein are illustrative and not restrictive.

Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail. Regarding applicability of 35 U.S. C. § 112, ¶ 6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

Reference will now be made in detail to embodiments of the present disclosure, examples of which are illustrated in the accompanying drawings. Wherever possible, the same reference numbers will be used throughout the drawings to refer to the same or like parts. The present invention can be understood more readily by reference to the following detailed description of the invention and the examples included therein. Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described. All publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this present disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening”can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed devices, systems, and articles of the present disclosure as well as the devices themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the present disclosure. Thus, if there are a variety of additional steps that can be performed it is understood that each of these additional steps can be performed with any specific aspect or combination of aspects of the methods of the present disclosure.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result. All publications mentioned herein are incorporated herein by reference to disclose and describe the methods and/or materials in connection with which the publications are cited.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods.

Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header. In the following detailed description, reference is made to the accompanying drawings, which form a part hereof. In the drawings, similar symbols typically identify similar components, unless context dictates otherwise.

The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, separated, and designed in a wide variety of different configurations, all of which are explicitly contemplated herein. The present disclosure is directed to portable solar farm systems that can be readily transported, deployed, and adjusted to generate electrical power in various locations and conditions. While specific examples may be provided, the disclosure is not limited to these particular embodiments. The principles described herein may be applied to a wide range of portable solar energy applications beyond those explicitly discussed.

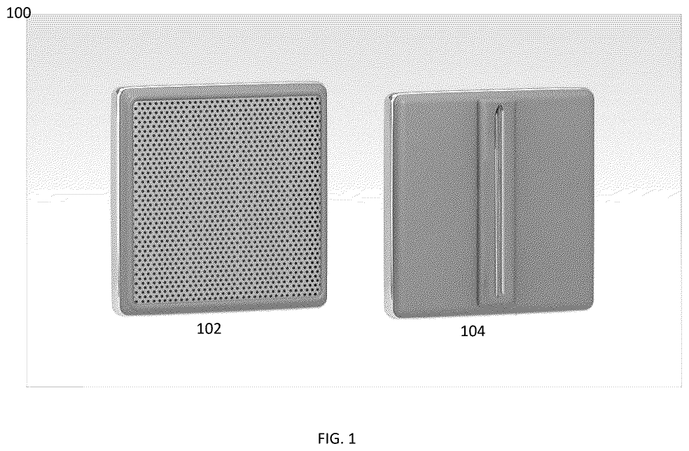

Referring to FIG. 1, an exemplary wearable speaker device 100 is shown. The device 100 may have a generally rectangular shape with dimensions of approximately 1 inch by 3 inches, although these dimensions may vary. In one or more embodiments, the dimensions may be lesser or greater as needed. The front view 102 shows a perforated surface with small, evenly distributed holes that may allow sound to pass through. The rear view 104 shows a smooth surface with a vertical rectangular slot 106 that may accommodate a fastening clip.

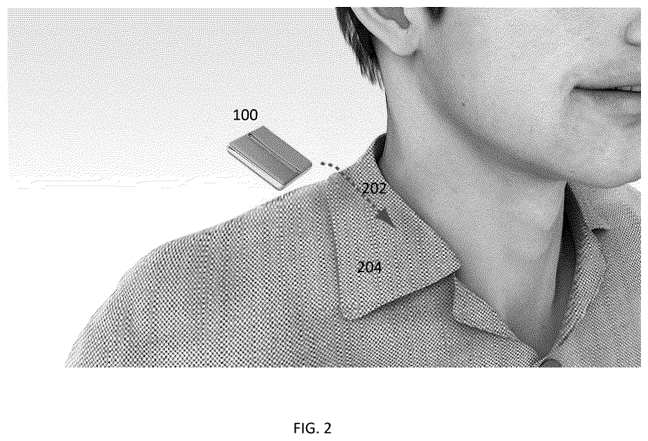

FIG. 2 illustrates how the wearable speaker device 100 may be clipped onto a user's clothing. A red dashed arrow 202 indicates the direction in which the device 100 may be attached to the collar of a shirt 204. The device 100 may be positioned below the user's ear to provide optimal audio output.

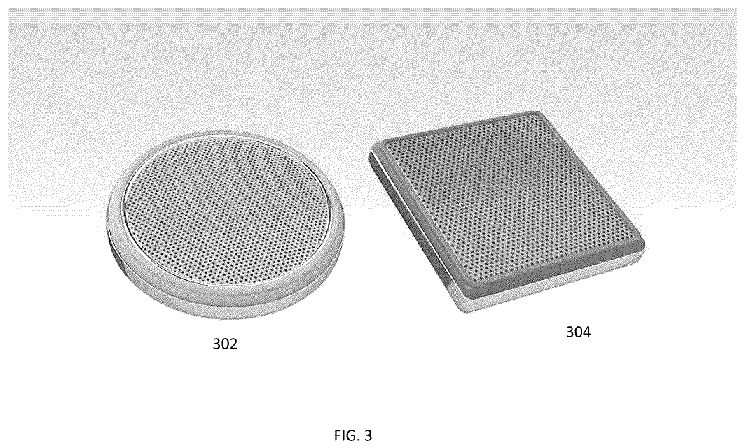

As shown in FIG. 3, the wearable speaker devices may be available in different configurations and colors. For example, a round device 302 with a yellow rim and an orange perforated surface may be provided. Alternatively, a rectangular device 304 with a blue perforated surface and a gray rim may be offered. These variations may allow users to choose a device that suits their personal preferences or style.

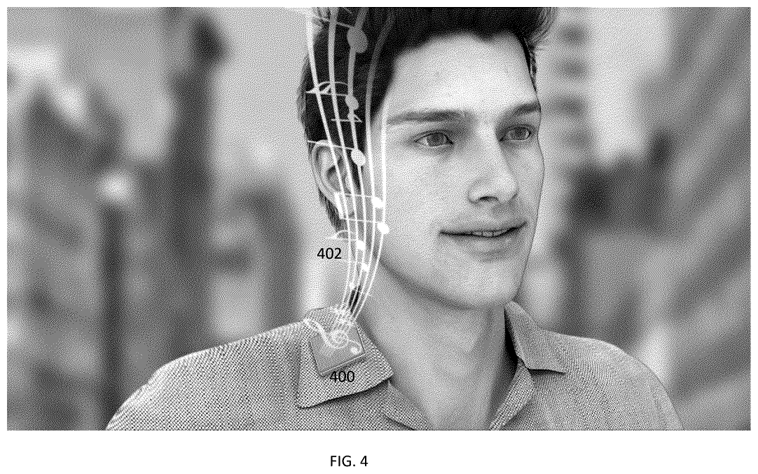

FIG. 4 depicts a user wearing an exemplary wearable speaker device 400. The device 400 is shown attached to the collar of the user's shirt. Musical notes 402 are illustrated emanating from the device 400, representing the audio output directed towards the user's ear.

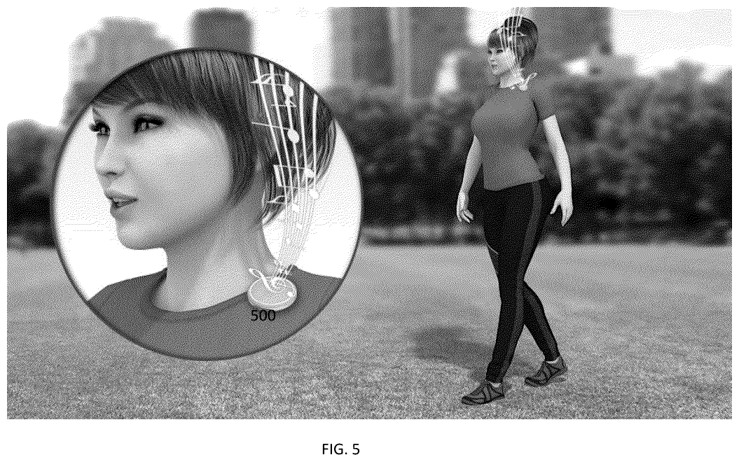

Similarly, FIG. 5 shows another user wearing a wearable speaker device 500. A circular inset highlights the device 500 positioned near the user's ear, with musical notes indicating sound transmission.

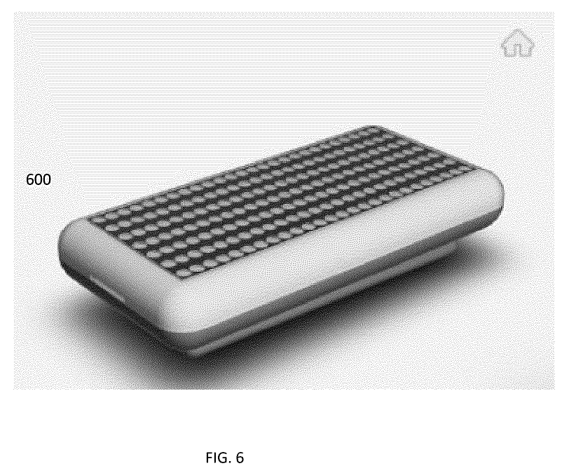

Referring to FIG. 6, a detailed view of an exemplary wearable speaker device 600 is provided. The device 600 may have a rectangular shape with rounded edges. The top surface may feature a grid-like pattern, which may represent speaker openings or a protective grille. The sides of the device may be white, while the bottom part may be blue. This color scheme is exemplary, and other color combinations may be used.

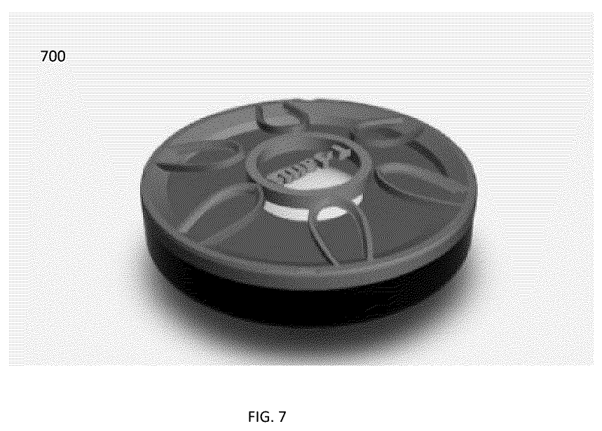

FIG. 7 illustrates internal components of an exemplary wearable speaker device 700. The device 700 may include a circular component at its center, which may represent a speaker driver. Surrounding the central component, several elongated loops may be arranged radially, potentially representing other internal elements such as a battery, Bluetooth module, or amplifier circuitry.

In various embodiments, the wearable speaker devices may include one or more of the following components:

a. A speaker unit for audio output

b. A Bluetooth module for wireless connectivity with audio source devices

c. A rechargeable battery to power the device

d. A fastening clip to attach the device to clothing

e. Control buttons for power, volume adjustment, and Bluetooth pairing

f. A microphone for hands-free calling functionality

g. An amplifier circuit to boost audio signals

h. A charging port for connecting to a power source

The wearable speaker devices may be sold in pairs, with one device intended for use near each ear. The devices may be designed to work in conjunction with each other to provide stereo audio output.

In some embodiments, a charging device may be provided with the wearable speakers. The charging device may be compatible with standard power outlets and vehicle charging ports. It may include appropriate electrical wiring and connectors for power transfer, as well as a charging interface compatible with the speakers.

The wearable speaker devices may operate as follows:

1. A user may clip the devices onto their clothing, positioning them below each ear.

2. The user may power on the devices using a designated power button.

3. The devices may enter Bluetooth pairing mode, allowing the user to connect them to an audio source device such as a smartphone, tablet, or computer.

4. Once paired, the devices may receive audio signals via Bluetooth.

5. The devices may process and amplify the received audio signals.

6. The amplified signals may be converted into sound waves and output through the speakers.

7. The user may adjust the volume using controls on the devices or the audio source.

8. When not in use, the user may remove the devices and connect them to the charging device to recharge the batteries.

The wearable speaker devices may be used in various environments, including workplaces, public spaces, vehicles, and home settings. They may allow users to enjoy audio content while maintaining awareness of their surroundings, potentially improving safety in situations where complete audio isolation could be hazardous.

In some embodiments, the devices may include additional features such as:

a. Voice assistant integration for hands-free control

b. Noise-cancellation technology for improved audio clarity

c. Water-resistant design for use in various weather conditions

d. Customizable equalizer settings accessible through a companion smartphone app

e. Multi-device pairing capability for seamless switching between audio sources

In some embodiments, the wearable audio system may include alternative configurations for securing the speaker devices near the user's ears. The system may comprise a neck band or collar that extends around the back of the user's neck. This neck band may be made of a flexible material such as plastic or silicone to comfortably conform to the user's neck. Speaker housings may be attached to or integrated into the ends of the neck band, positioned to rest below each of the user's ears when worn. The neck band configuration may allow for a more secure fit compared to individual clip-on speakers, which may be beneficial for active users. The band may be adjustable to accommodate different neck sizes. In some versions, the speaker housings may be removable from the band to allow for customization or replacement.

Alternative attachment mechanisms may also be employed to secure speaker devices below the ears. For example, the system may utilize adhesive pads or magnets integrated into the speaker housings to temporarily affix the devices to the user's skin or clothing. Another option may involve thin, flexible wire or plastic arms that hook over and behind the ears to hold the speakers in place below the ears.

The speaker housings themselves may come in various shapes and sizes to suit different user preferences and clothing styles. In addition to the rectangular design described previously, circular, oval, or custom-molded shapes may be offered. The housing dimensions may range from as small as 0.5 inches to as large as 2 inches in diameter or width. In one or more embodiments, the dimensions may be lesser or greater as needed.

Regardless of the specific attachment method or housing shape, the core functionality of providing audio playback from a position below the user's ears may be maintained across different embodiments. This below-ear positioning may allow ambient sounds to reach the user's ears unimpeded while still delivering personal audio content.

The wireless communication capabilities of the speaker devices may extend beyond simple audio playback. In some implementations, the devices may include microphones to enable two-way communication. This may allow for hands-free phone calls as well as voice control of the audio system and connected devices. Advanced signal processing techniques may be employed to optimize the audio output for the below-ear position. This may include adjusting frequency response, volume levels, and directionality to provide clear, intelligible audio without the need for excessively high volumes that could potentially damage hearing.

The specific features, dimensions, and design elements described herein are exemplary and may be modified or adapted in various ways without departing from the spirit and scope of the invention. While this specification contains many specifics, these should not be construed as limitations on the scope of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes”should be interpreted as “includes but is not limited to,”etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”and “one or more”to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entirety are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Although very narrow claims are presented herein, it should be recognized the scope of this disclosure is much broader than presented by the claims. It is intended that broader claims will be submitted in an application that claims the benefit of priority from this application. It should be understood that the above-described embodiments are merely possible examples of implementations, merely set forth for a clear understanding of the principles of the present disclosure. Many variations and modifications may be made to the above-described embodiments without departing substantially from the spirit and principles of the disclosure. All such modifications and variations are intended to be included herein within the scope of this disclosure and protected by the following claims.

What is claimed is:

1. A wearable audio system comprising:
a pair of portable speaker devices, each speaker device comprising:
a housing;
a speaker unit disposed within the housing;
a fastening clip attached to the housing and configured to removably secure the speaker device to a user's clothing;
a wireless communication module configured to receive audio signals from an audio source device; and
a battery configured to power the speaker device;
wherein the pair of speaker devices are configured to be worn by a user with one speaker device positioned below each ear.

2. The wearable audio system of claim 1, wherein the wireless communication module comprises a Bluetooth module.

3. The wearable audio system of claim 1, wherein each speaker device further comprises control buttons for at least one of: power control, volume adjustment, or wireless pairing.

4. The wearable audio system of claim 1, further comprising a charging device configured to recharge the batteries of the speaker devices.

5. The wearable audio system of claim 1, wherein each speaker device has dimensions of at least 1 inch by 3 inches.

6. The wearable audio system of claim 1, wherein each speaker device further comprises a microphone for hands-free calling functionality.

7. The wearable audio system of claim 1, wherein the housing of each speaker device comprises a perforated front surface.

8. A method of using a wearable audio system, the method comprising:
attaching a first portable speaker device to a user's clothing below a first ear;
attaching a second portable speaker device to the user's clothing below a second ear;
wirelessly pairing the first and second portable speaker devices with an audio source device;
receiving audio signals from the audio source device at the first and second portable speaker devices; and
outputting audio content through speaker units of the first and second portable speaker devices.

9. The method of claim 8, further comprising adjusting a volume of the audio content using controls on at least one of the first portable speaker device, the second portable speaker device, or the audio source device.

10. The method of claim 8, wherein wirelessly pairing comprises establishing a Bluetooth connection between the first and second portable speaker devices and the audio source device.

11. The method of claim 8, further comprising recharging batteries of the first and second portable speaker devices using a charging device.

12. The method of claim 8, further comprising conducting a hands-free phone call using a microphone integrated into at least one of the first or second portable speaker devices.

13. A portable speaker device comprising:
a housing having a front surface and a rear surface;
a speaker unit disposed within the housing and configured to output audio through the front surface;
a fastening clip attached to the rear surface of the housing and configured to removably secure the portable speaker device to a user's clothing;
a wireless communication module disposed within the housing and configured to receive audio signals from an audio source device;
a battery disposed within the housing and configured to power the portable speaker device; and
control buttons disposed on the housing for controlling at least one function of the portable speaker device.

14. The portable speaker device of claim 13, wherein the front surface of the housing is perforated to allow sound to pass through.

15. The portable speaker device of claim 13, wherein the wireless communication module comprises a Bluetooth module.

16. The portable speaker device of claim 13, further comprising a microphone disposed within the housing for hands-free calling functionality.

17. The portable speaker device of claim 13, wherein the housing has a rectangular shape with rounded edges.

18. The portable speaker device of claim 13, wherein the control buttons comprise at least one of: a power button, volume adjustment buttons, or a wireless pairing button.

19. The portable speaker device of claim 13, further comprising a charging port configured to connect to a charging device for recharging the battery.

20. The portable speaker device of claim 13, wherein the housing has dimensions of at least 1 inch by 3 inches.
